(19) United States
(12) Patent Application Publication
(10) Pub. No.: US 2014/0137092 A1
(43) Pub. Date: May 15, 2014

(54) INFORMATION PROCESSING APPARATUS, INFORMATION PROCESSING SYSTEM, NON-TRANSITORY COMPUTER-READABLE STORAGE MEDIUM HAVING STORED THEREIN INFORMATION PROCESSING PROGRAM, AND INFORMATION PROCESSING METHOD

(71) Applicant: NINTENDO CO., LTD., Kyoto (JP)

(72) Inventors: Masani UEDA, Kyoto (JP); Yoichi OOSHIMA, Kyoto (JP); Yohei TSUKADA, Kyoto (JP); Yosuke FUJINO, Kyoto (JP); Jumpei WADA, Kyoto (JP)

(73) Assignee: NINTENDO CO., LTD., Kyoto (JP)

(21) Appl. No.: 14/036,035

(22) Filed: Sep. 25, 2013

(30) Foreign Application Priority Data
Nov. 15, 2012 (JP) 2012-251046

(51) Int. Cl. G06F 9/445

(52) U.S. Cl. CPC G06F 8/65
USPC 717/168

(57) ABSTRACT

In an example of a game apparatus, first system software, second system software for updating, and third system software for executing a game program are stored in advance in a system storage unit. The game apparatus acquires pieces of update data for the pieces of system software and updates the second system software during the execution of the first system software. Thereafter, the game apparatus is restarted, the second system software is started, and the first system software and the third system software are updated during the execution of the second system software.

### CROSS REFERENCE TO RELATED APPLICATION

The disclosure of Japanese Patent Application No. 2012-251046, filed on Nov. 15, 2012, is incorporated herein by reference.

### FIELD

The technology disclosed herein relates to an information processing apparatus, an information processing system, and an information processing method that are capable of updating software, and a non-transitory computer-readable storage medium having stored therein an information processing program capable of updating software.

### BACKGROUND AND SUMMARY

Conventionally, there is a device that, under control of firmware built into the device in advance, downloads a new version of the firmware from a network and updates the firmware to the new version of the firmware.

In the conventional technique, however, the firmware is updated under control of the firmware that is currently being executed. Thus, there is a limitation that, for example, it is not possible to perform a significant update. Thus, there is room for improvement in an easy update.

Therefore, it is an object of an exemplary embodiment to provide a technique capable of easily updating system software.

To achieve the above object, the exemplary embodiment employs the following configurations.

An exemplary embodiment is an information processing apparatus to be controlled by system software, and the information processing apparatus includes a first storage unit, a second storage unit, a starting unit, a first update data acquisition unit, and a first update unit. The first storage unit stores first system software. The second storage unit stores second system software for updating. The starting unit starts any one of a plurality of pieces of system software. The first update data acquisition unit acquires first update data for updating the first system software. The first update unit, while the information processing apparatus is controlled by the second system software after the second system software has been started by the starting unit, updates the first system software stored in the first storage unit, using the first update data.

Based on the above, the information processing apparatus has the first system software and the second system software for updating, and the first system software is updated while the information processing apparatus is controlled by the second system software. Thus, it is possible to easily update the first system software. It should be noted that “update” means any change including the addition, the modification, and the deletion of functions of software, regardless of the scale.

In addition, in another configuration, the information processing apparatus may further include a second update data acquisition unit and a second update unit. The second update data acquisition unit acquires second update data for updating the second system software. The second update unit, while the information processing system is controlled by the first system software after the first system software has been started by the starting unit, updates the second system software stored in the second storage unit, using the second update data.

Based on the above, it is also possible to update the second system software. The second system software is updated while the information processing apparatus is controlled by the first system software. This makes it possible to easily update the second system software.

In addition, in another configuration, while the information processing apparatus is controlled by the second system software after the second system software has been started by the starting unit after the second system software had been updated by the second update unit, the first system software may be updated by the first update unit.

Based on the above, first, the second system software is updated, and next, the first system software is updated. Thus, the update of the second system software that is required for updating the first system software can be performed before the update of the first system software. This makes it possible to, for example, easily make a major improvement in the first system software.

In addition, in another configuration, while the information processing apparatus is controlled by the second system software after the second system software has been automatically started by the starting unit after the second system software had been updated by the second update unit, the first system software may be automatically updated by the first update unit.

Based on the above, it is possible to automatically update the second system software and update the first system software by a successive procedure.

In addition, in another configuration, the information processing apparatus may further include a third storage unit, a third update data acquisition unit, and a third update unit. The third storage unit stores third system software for executing an application. The third update data acquisition unit acquires third update data for updating the third system software. The starting unit starts any one of a plurality of pieces of system software including the first system software stored in the first storage unit, the second system software stored in the second storage unit, and the third system software stored in the third storage unit. The third update unit, while the information processing apparatus is controlled by the started system software after the first system software or the second system software has been started by the starting unit, updates the third system software stored in the third storage unit, using the third update data.

Based on the above, aside from the first system software, the third system software for executing an application is prepared. The third system software is updated while the information processing apparatus is controlled by the first system software or the second system software. Thus, it is possible to easily update the third system software, and it is also possible to, while the first system software is updated, not affect the operation of an application.

In addition, in another configuration, the first system software may be system software that is started when the information processing apparatus has been turned on.

Based on the above, the first system software can be system software that starts when the information processing apparatus has been turned on.

In addition, in another configuration, the first system software may provide a menu function for allowing a user to select an application.

Based on the above, it is possible to provide a menu function.

In addition, in another configuration, the first system software may provide a menu function for allowing a user to select an application. The update of the second system software by the second update unit is selected and executed by the user using the menu function.

Based on the above, it is possible to update the second system software through a menu.

In addition, in another configuration, the first system software and the second system software may be stored in advance in the first storage unit and the second storage unit, respectively.

Based on the above, it is possible to store the first system software and the second system software in advance in the information processing apparatus.

It should be noted that another exemplary embodiment may be an information processing system (including one or more apparatuses), or may be a program for performing the processing of the above update, or may be an update method.

Based on the exemplary embodiment, it is possible to easily update system software.

These and other objects, features, aspects and advantages of the exemplary embodiment will become more apparent from the following detailed description of the exemplary embodiments when taken in conjunction with the accompanying drawings.

### BRIEF DESCRIPTION OF THE DRAWINGS

FIG. 1 is a block diagram showing a non-limiting example of the internal configuration of a game apparatus 10;

FIG. 2 is a diagram showing a non-limiting example of the state where the game apparatus 10 downloads pieces of system software from a server on the Internet and updates pieces of system software;

FIG. 3 is a diagram showing a non-limiting example of an overview of the flow of an update process;

FIG. 4 is a diagram showing a non-limiting example of an image displayed on a display apparatus 40 when first system software has started;

FIG. 5 is a diagram showing a non-limiting example of the directory structure of system software before and after an update;

FIG. 6 is a flow chart showing non-limiting examples of the details of the processing performed by the game apparatus 10;

FIG. 7 is a flow chart showing non-limiting examples of the details of an update process in step S104 of FIG. 6; and

FIG. 8 is a flow chart showing non-limiting examples of the details of an application process in step S106 of FIG. 6.

### DETAILED DESCRIPTION OF NON-LIMITING EXAMPLE EMBODIMENTS

[1. Configuration of Game Apparatus]

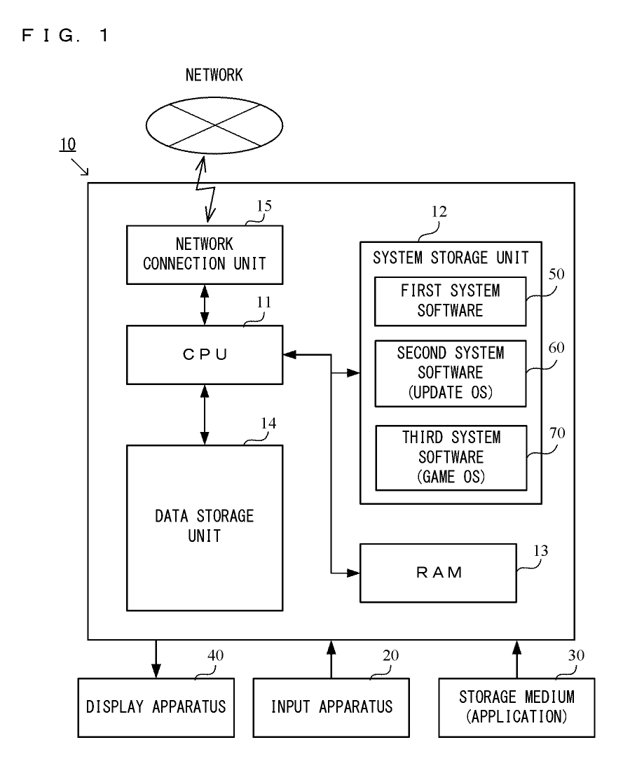

With reference to the drawings, a game apparatus 10 according to an exemplary embodiment is described below. FIG. 1 is a block diagram showing the internal configuration of the game apparatus 10. As shown in FIG. 1, the game apparatus 10 includes a CPU 11, which makes various calculations in accordance with a program, a system storage unit 12, a RAM 13, a data storage unit 14, and a network connection unit 15. The game apparatus 10 receives an input from an input apparatus 20 operated by a user, performs processing, and outputs an image to a display apparatus 40.

The system storage unit 12 is a non-volatile storage device and may be composed of, for example, a flash memory or a hard disk device. The system storage unit 12 stores first system software (OS: operating system) 50, second system software 60 for updating, and third system software 70. In the game apparatus 10, two pieces of system software do not operate simultaneously, and any one of the pieces of first to third system software is selected and started.

The first system software 50 is basic software stored in advance for managing and controlling the hardware in the game apparatus 10. The first system software 50 performs input/output management, performs the resource management of the hardware (the CPU 11, the system storage unit 12, the RAM 13, the data storage unit 14, and the like), and manages a file system and the like. The first system software 50 normally starts when the game apparatus 10 has been turned on, and the first system software 50 provides a menu function for receiving an operation of the user.

The second system software 60 is basic software stored in advance for managing and controlling the hardware in the game apparatus 10. The second system software 60 is system software that is started when the first system software and/or the third system software are updated. Hereinafter, the second system software 60 may occasionally be referred to as an “update OS”.

The third system software 70 is basic software stored in advance for managing and controlling the hardware in the game apparatus 10. The third system software 70 is system software that is started when a game program (application) is executed by the game apparatus 10. Hereinafter, the third system software 70 may occasionally be referred to as a “game OS”. The game program operates on the third system software 70 and operates using various functions (an API and the like) provided by the third system software 70. The game program may be stored in a portable storage medium 30, such as an optical disk, detachably connected to the game apparatus 10, and may be provided to the game apparatus 10. Alternatively, the game program may be stored in advance in the game apparatus 10, or may be provided to the game apparatus 10 via a network.

Each of the pieces of first to third system software is substantially a plurality of groups of programs (files). The groups of programs are stored in advance in different areas in the system storage unit 12.

The data storage unit 14 is a non-volatile storage device and may be composed of, for example, a flash memory or a hard disk device. The data storage unit 14 can store data acquired from a server on the Internet by the game apparatus 10. It should be noted that the system storage unit 12 and the data storage unit 14 may be achieved by physically the same hardware, or may be achieved by pieces of hardware different from each other.

The network connection unit 15 is a communication module for connecting to a network such as the Internet. For example, the game apparatus 10 can acquire data from a server on the Internet via the network connection unit 15.

(Overview of Update)

Next, the update of pieces of system software according to the exemplary embodiment is described. It should be noted that in the present specification, any change made in software, including a major improvement and a minor modification of system software, the addition, the change, and the deletion of functions, and the like, is referred to as an “update”.

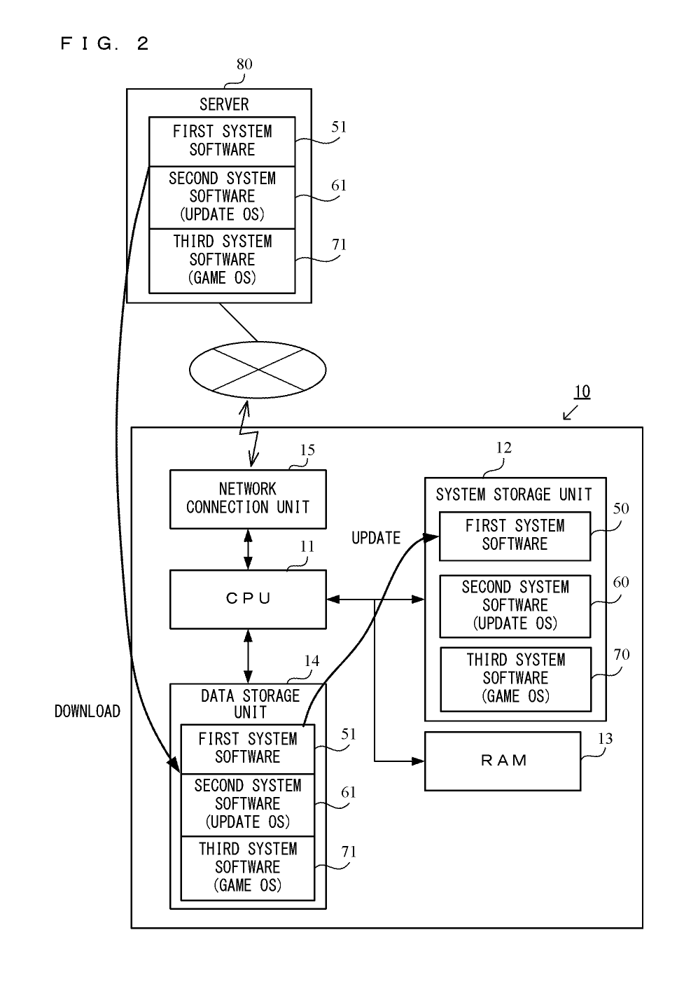

FIG. 2 is a diagram showing the state where the game apparatus 10 downloads pieces of system software from a server on the Internet and updates pieces of system software.

As shown in FIG. 2, a server 80 on the Internet stores first system software 51, which is the latest version, second system software 61, which is the latest version, and third system software 71, which is the latest version.

First, the game apparatus 10 accesses the server 80 on the Internet via the network connection unit 15, downloads the first system software 51, the second system software 61, and the third system software 71, and stores the first system software 51, the second system software 61, and the third system software 71 in the data storage unit 14. Then, the game apparatus 10 updates the pieces of system software stored in the system storage unit 12, using pieces of data of the pieces of downloaded system software.

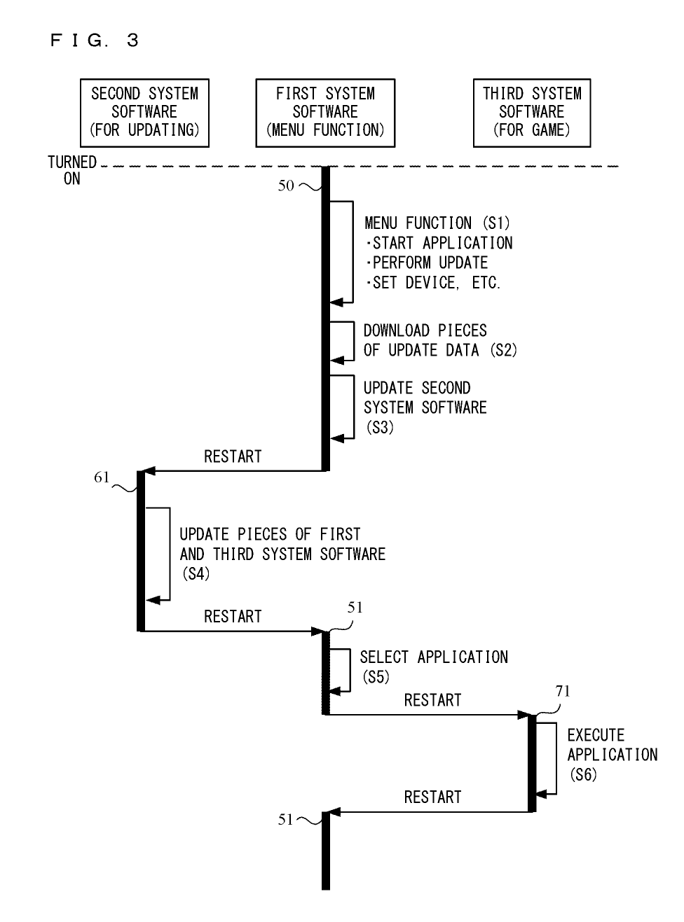

FIG. 3 is a diagram showing an overview of the flow of an update process. As shown in FIG. 3, first, if the game apparatus 10 has been turned on, the first system software starts and provides the menu function (S1).

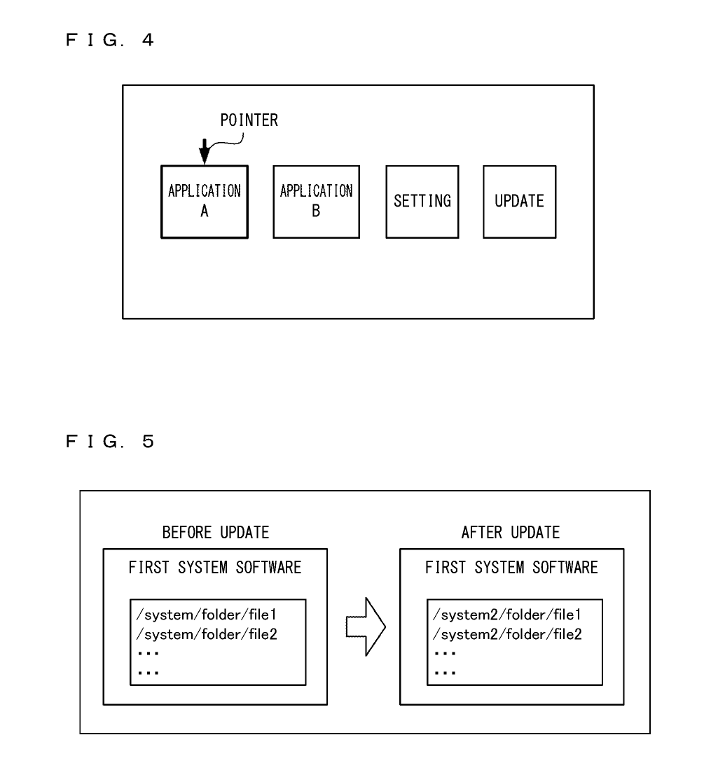

FIG. 4 is a diagram showing an example of an image displayed on the display apparatus 40 when the first system software has started. As shown in FIG. 4, a plurality of selection items are displayed on the display apparatus 40 so that if the user has selected any one of the plurality of selection items using the input apparatus 20, processing based on the selected item is performed. For example, if the user has selected “update”, an update process is started.

Referring back to FIG. 3, if “update” has been selected, the game apparatus 10 accesses the server 80 and downloads pieces of update data for the pieces of system software (S2). Here, pieces of update data for updating the pieces of first to third system software are downloaded. It should be noted that the update data for updating the first system software may be the entirety of the latest first system software (that is, all data of the first system software), or may be data of only the updated part (a patch or the like) of the first system software. The same applies to the pieces of update data for the other pieces of system software.

After the downloading of the pieces of update data has been completed, the second system software is updated while the game apparatus 10 is controlled by the first system software (S3). That is, the first system software or an update application that operates on the first system software updates the second system software 60 stored in the system storage unit 12, using the downloaded update data for the second system software 61.

If the update of the second system software has been completed, the game apparatus 10 restarts. If the game apparatus 10 has restarted, the second system software 61 is started. That is, the game apparatus 10 starts the updated second system software stored in the system storage unit 12.

Next, while the game apparatus 10 is controlled by the second system software, the first system software and the third system software are updated using the pieces of update data for the first system software and the third system software downloaded from the server 80 (S4). That is, the second system software or an update application that operates on the second system software updates the first system software 50 and the third system software 70 stored in the system storage unit 12, using the first system software 51 and the third system software 71 that have been downloaded.

If the update of the first system software and the third system software has been completed, the game apparatus 10 restarts. Consequently, the first system software 51 starts, and a menu screen shown in FIG. 4 is displayed. Then, if the user has selected an application on the menu screen (S5), the game apparatus 10 restarts, and the third system software 71 starts. The application selected by the user is executed on the third system software (S6). If the execution of the application has ended, the game apparatus 10 restarts, and the first system software 51 starts.

As described above, in the exemplary embodiment, if the first system software, which normally starts when the game apparatus 10 has been turned on, is updated, the second system software for updating starts, and the second system software updates the first system software. This makes it possible to update the first system software even if a significant change has been made in the first system software.

That is, during the execution of the first system software, it is not possible to make a significant change in the first system software itself. FIG. 5 is a diagram showing an example of the directory structure of system software before and after an update.

For example, as shown in FIG. 5, during the execution of the first system software, it is not possible to make a significant change such as changing the directory structure of system files included in the first system software. That is, while the game apparatus 10 is controlled by certain system software, a plurality of programs included in the certain system software are being executed. Thus, it is not possible to make changes (replacement, changes in a name and a path, and the like) in the programs themselves that are currently being executed and in files and the like used by the programs.

In the exemplary embodiment, however, if the first system software is updated, the second system software starts. This makes it possible to freely access the file system of the first system software and therefore easily update the first system software.

In addition, before the first system software is updated, the second system software for updating is updated. Thus, even if a significant change is made in the first system software, also the second system software can be changed in accordance with the change. This makes it possible to easily and smoothly update the system. That is, if the second system software is not updated from the initial version, it may not be possible to make a significant change in the first system software, which has not been initially expected. In the exemplary embodiment, however, it is possible to update also the second system software while the first system software is operating. This makes it possible to update the second system software so as to correspond to a significant change in the first system software. Then, the updated second system software is started, and the second system software updates the first system software, whereby it is possible to make a significant change in the first system software.

In addition, in the exemplary embodiment, if the update process has been started, the second system software is automatically updated, the first system software is automatically switched to the second system software (the game apparatus 10 is restarted, and the second system software is started), the first (and third) system software is automatically updated, and the second system software is automatically switched to the first system software (the game apparatus 10 is restarted, and the first system software is started). This makes it possible to automatically and smoothly perform a plurality of updates by a successive procedure.

In addition, in the exemplary embodiment, the game program (application) operates on the third system software. Thus, the update of the first system software, which provides the menu function, does not affect the third system software and does not affect the operation of the game program, either. Similarly, the third system software may be updated in order to add or change functions to be provided to the application. In this case, the update of the third system software does not affect the first system software. In the exemplary embodiment, the first system software and the third system software are thus built into the game apparatus 10 and configured to provide functions different from each other. Then, each of the pieces of system software is updated by the second system software for updating, and therefore, one does not affect the other. Thus, even if a significant improvement is made, it is possible to easily and smoothly update the pieces of system software.

It should be noted that the update data for each of the pieces of system software does not need to be provided from a server, and may be provided from a storage medium such as an optical disk or a semiconductor.

In addition, each of the pieces of system software does not necessarily need to be updated, and a piece of system software is not updated if it does not have update data. For example, only the first system software may be updated, or only the third system software may be updated.

In addition, the second system software or an application that operates on the second system software updates the first system software and the third system software. Alternatively, the first system software or an application that operates on the first system software may update the third system software.

In addition, the game apparatus 10 may download, as update data for updating each of the pieces of system software, the entirety of the latest system software (that is, all data of the system software), or may download data including only the updated part of the system software, as update data.

(Detailed Flow)

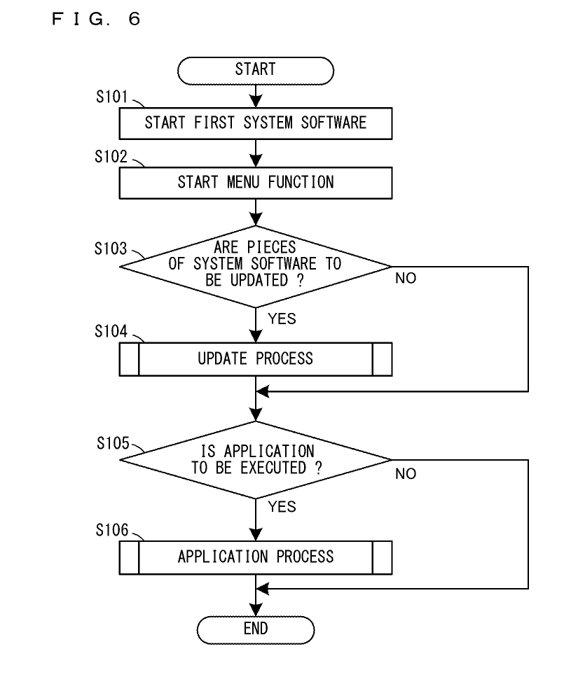

Next, the details of the above update process are described. FIG. 6 is a flow chart showing the details of the processing performed by the game apparatus 10.

As shown in FIG. 6, if the game apparatus 10 has been turned on, the game apparatus 10 (the CPU 11) starts the first system software (step S101), and starts the menu function (step S102). Next, the game apparatus 10 determines whether or not the pieces of system software are to be updated (step S103). For example, if the user has selected an update on the menu screen, the game apparatus 10 determines that the pieces of system software are to be updated.

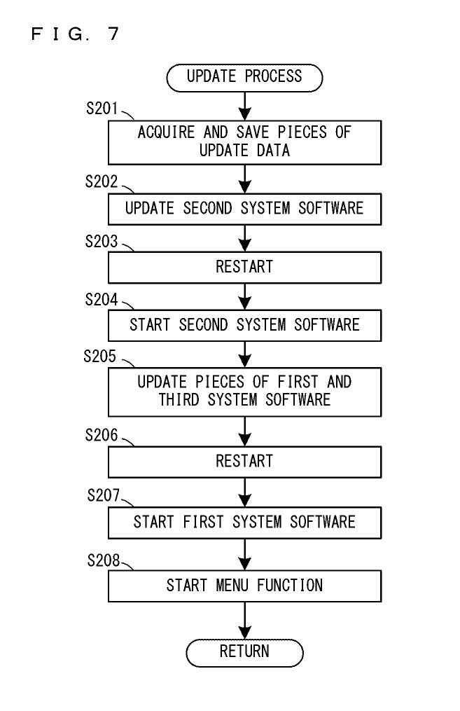

If having determined that the pieces of system software are to be updated (step S103: YES), the game apparatus 10 performs an update process (step S104). The details of the update process will be described later with reference to FIG. 7.

After step S104, the game apparatus 10 determines whether or not an application is to be executed (step S105). Specifically, if the user has selected an application (game program) on the menu screen, the game apparatus 10 determines that an application is to be executed.

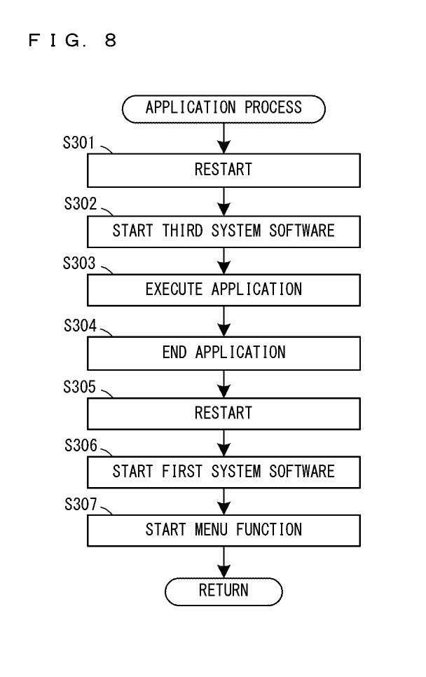

If having determined that an application is to be executed (step S105: YES), the game apparatus 10 performs an application process (step S106). The details of the application process will be described later with reference to FIG. 8. It should be noted that the processes of steps S103 to S106 are repeatedly performed. This is the end of the description of FIG. 6.

(Update Process)

Next, with reference to FIG. 7, the details of the update process are described. FIG. 7 is a flow chart showing the details of the update process in step S104 of FIG. 6.

As shown in FIG. 7, the game apparatus 10 accesses the server 80 and checks whether or not pieces of update data for the pieces of system software are present. If pieces of update data are present, the game apparatus 10 acquires the pieces of update data and saves the pieces of update data in the data storage unit 14 (step S201). Next, the game apparatus 10 updates the second system software using the acquired update data (step S202). After the update has been completed, the game apparatus 10 is restarted (step S203). If having been restarted, the game apparatus 10 starts the second system software (the update OS) (step S204).

If the second system software has started, the game apparatus 10 updates the first system software and the third system software using the pieces of update data acquired in step S201 (step S205). After the update has been completed, the game apparatus 10 is restarted (step S206), and the first system software is started (step S207). Then, if the start of the first system software has been completed, the menu function is started (step S208), and the process shown in FIG. 7 ends.

(Application Process)

Next, with reference to FIG. 8, the details of the application process are described. FIG. 8 is a flow chart showing the details of the application process in step S106 of FIG. 6.

As shown in FIG. 8, first, the game apparatus 10 is restarted (step S301), and the game apparatus 10 starts the third system software (the game OS) (step S302). If the start of the third system software has been completed, the game apparatus 10 executes the application selected by the user (step S303).

If the execution of the application has been started and a predetermined ending condition has been satisfied (for example, the fact that the user has given an instruction to end the application), the game apparatus 10 ends the application (step S304). Then, the game apparatus 10 is restarted (step S305), and the first system software is started (step S306). If the start of the first system software has been completed, the menu function is started again (step S307). This is the end of the process shown in FIG. 8.

As described above, in the exemplary embodiment, after the second system software for updating has been updated in the update process, the second system software automatically starts. Then, during the execution of the second system software, the first system software is updated. Then, if the update of the first system software has ended, the first system software starts again. Thus, even if it is necessary to make a significant improvement in system software, it is possible to easily update the system software.

It should be noted that the flow charts shown in FIGS. 6 to 8 are merely illustrative. Thus, the processing order of the steps may be changed, or a process may be added, changed, or deleted, so long as similar results are obtained. Alternatively, some or all of the processing of the flow charts may be performed by another general-purpose processor or another dedicated circuit other than the CPU 11.

In addition, the processing performed by the game apparatus 10 may be performed by any information processing apparatus (information processing system).

Examples of any information processing apparatus (system) include personal computers, servers, smartphones, mobile phones, PDAs, game apparatuses, tablet computers, and the like.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information processing apparatus to be controlled by system software, the information processing apparatus comprising:
a first storage unit configured to store first system software;
a second storage unit configured to store second system software for updating;
a starting unit configured to start any one of a plurality of pieces of system software;
a first update data acquisition unit configured to acquire first update data for updating the first system software; and
a first update unit configured to, while the information processing apparatus is controlled by the second system software after the second system software has been started by the starting unit, update the first system software stored in the first storage unit, using the first update data.

2. The information processing apparatus according to claim 1, further comprising:
a second update data acquisition unit configured to acquire second update data for updating the second system software; and
a second update unit configured to, while the information processing system is controlled by the first system software after the first system software has been started by the starting unit, update the second system software stored in the second storage unit, using the second update data.

3. The information processing apparatus according to claim 2, wherein
while the information processing apparatus is controlled by the second system software after the second system software has been started by the starting unit after the second system software had been updated by the second update unit, the first system software is updated by the first update unit.

4. The information processing apparatus according to claim 3, wherein
while the information processing apparatus is controlled by the second system software after the second system software has been automatically started by the starting unit after the second system software had been updated by the second update unit, the first system software is automatically updated by the first update unit.

5. The information processing apparatus according to claim 1, further comprising:
a third storage unit configured to store third system software for executing an application; and
a third update data acquisition unit configured to acquire third update data for updating the third system software, wherein
the starting unit starts any one of a plurality of pieces of system software including the first system software stored in the first storage unit, the second system software stored in the second storage unit, and the third system software stored in the third storage unit,
the information processing apparatus further comprising
a third update unit configured to, while the information processing apparatus is controlled by the started system software after the first system software or the second system software has been started by the starting unit, update the third system software stored in the third storage unit, using the third update data.

6. The information processing apparatus according to claim 1, wherein
the first system software is system software that is started when the information processing apparatus has been turned on.

7. The information processing apparatus according to claim 1, wherein
the first system software provides a menu function for allowing a user to select an application.

8. The information processing apparatus according to claim 2, wherein
the first system software provides a menu function for allowing a user to select an application, and
the update of the second system software by the second update unit is selected and executed by the user using the menu function.

9. The information processing apparatus according to claim 1, wherein
the first system software and the second system software are stored in advance in the first storage unit and the second storage unit, respectively.

10. An information processing system to be controlled by system software, the information processing system comprising:
a first storage unit configured to store first system software;
a second storage unit configured to store second system software for updating;
a starting unit configured to start any one of a plurality of pieces of system software;
a first update data acquisition unit configured to acquire first update data for updating the first system software; and
a first update unit configured to, while the information processing system is controlled by the second system software after the second system software has been started by the starting unit, update the first system software stored in the first storage unit, using the first update data.

11. A non-transitory computer-readable storage medium having stored therein an information processing program to be executed by a computer of an information processing apparatus to be controlled by system software, the information processing program causing the computer to execute:
starting any one of a plurality of pieces of system software including first system software and second system software;
acquiring first update data for updating the first system software; and
while the information processing apparatus is controlled by the second system software after the second system software has been started, updating the first system software using the first update data.

12. An information processing method to be executed by an information processing system to be controlled by system software, the information processing method comprising:
starting any one of a plurality of pieces of system software including first system software stored in a first storage unit and second system software for updating stored in a second storage unit;
acquiring first update data for updating the first system software; and
while the information processing system is controlled by the second system software after the second system software has been started, updating the first system software stored in the first storage unit, using the first update data.
